(19) United States
(12) Patent Application Publication
(10) Pub. No.: US 2002/0072049 A1
(43) Pub. Date: Jun. 13, 2002

(54) Education event module and presentation

(76) Inventor: Coimbatore Krishnarao Prahalad, San Deigo, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/948,822

(22) Filed: Sep. 7, 2001

Related U.S. Application Data
(60) Provisional application No. 60/231,458, filed on Sep. 8, 2000.

(51) Int. Cl. G06F 7/00; G09B 25/00

(52) U.S. Cl. 434/365; 707/104.1

(57) ABSTRACT

A system and method for providing an electronic education course utilizing an event data model and learning desktop. The learning desktop includes a repository where student knowledge, ideas, concepts, discourse and/or interaction are captured, codified and tagged in real time. This information is input into the event data model enabling a teacher to create the initial top-level design of a course, which may be modified as the course progresses. For example, the students and teacher can amend or add to the initial course design by creating new events. Therefore, the system and method provide an evolving learning continuum that captures the flow of events as the course and student input develops. Additionally, student reaction to concepts over time or at a certain point in the session may be analyzed. Furthermore, the event data model enables the teacher to compare and track reaction to certain course elements among different sets of students or taught at different times.

### RELATED APPLICATION

This application claims priority to U.S. Provisional Application No. 60/231,458, filed Sep. 8, 2000 and titled “EDUCATION EVENT MODULE AND PRESENTATION,” which is hereby incorporated by reference in its entirety.

### BACKGROUND OF THE INVENTION

1. Field of the Invention

The present invention generally relates to the field of electronic education. More particularly, the invention relates to providing a system and method for rendering screen displays, enabling the creation of initial course events, and modifying the course events while a course is in progress based on student or teacher input or comments.

2. Description of the Related Technology

Educational techniques and theories have traditionally been confined by the limitations of a paper and pen environment and the time and space constraints imposed by in-class lectures and exams. Communications and collaboration between students and instructor in such a teaching environment are cumbersome and inefficient.

In addition, courses have traditionally been constrained by the available textbooks and the long lead-time necessary to update traditional textbooks and other course materials. Changes to course content, in a dynamic and real-time fashion, while a course is in progress due to student feedback and collaboration between students and instructor are difficult to accomplish and implement with paper books and hardcopy course materials. Further, if such changes are able to be made to a course based on student feedback, the process would likely have to be repeated in each subsequent offering of the course.

The use of the Internet and the World Wide Web has increased dramatically in recent years. As a consequence, websites have generally incorporated multitudes of features to accommodate the demands of their users. Therefore, websites have become more powerful and capable of performing increasingly difficult tasks and operations.

What is needed in the technology is a system and method for providing the electronic presentation and modification of course content and materials based on electronic dynamic feedback and collaborations between students and instructor. Such modification of course content would then be readily available for use in subsequent courses with little or no additional effort required. The system and method would utilize a network, for example the Internet, to allow electronic communications between users without geographical constraints.

### SUMMARY OF CERTAIN INVENTIVE ASPECTS

One aspect of the invention provides a method of modeling an educational course, the method comprising defining a category tree having a plurality of category nodes, wherein a plurality of the category nodes are representative of aspects of a course, associating at least one event with one of the nodes, wherein the event has an event description, and transmitting an electronic document from an educational server to a student, wherein the electronic document includes a hyperlink to the event.

Another aspect of the invention provides a system for modeling an educational course, the system comprising an event data module adapted to provide input mechanisms for entering course event data, wherein the input mechanisms comprise the configuration, definition, entry, assimilation and aggregation of course event data, an educational server adapted to process and store media assets and event index data for course events, and a presentation logic module adapted to transmit an electronic document from an educational server to a student, wherein the electronic document includes a hyperlink to the event.

### BRIEF DESCRIPTION OF THE DRAWINGS

The above and other aspects, features and advantages of the invention will be better understood by referring to the following detailed description, which should be read in conjunction with the accompanying drawings. These drawings and the associated description are provided to illustrate certain embodiments of the invention, and not to limit the scope of the invention.

FIG. 1 is a diagram of one example of a network configuration in which an education event module and presentation system may operate.

FIG. 2 is a diagram of an architecture of an event data module in accordance with one embodiment of an education event module and presentation system.

FIG. 3 is a block diagram of an initial skeleton of a course data model according to one embodiment of the ExperienceWare module shown in FIG. 2.

FIG. 4 is a block diagram of a final course data model according to one embodiment of the ExperienceWare module shown in FIG. 2.

FIG. 5 is a block diagram illustrating a generation of event envelopes according to one embodiment of the ExperienceWare module shown in FIG. 2.

FIG. 6 is an example of a learning desktop screen display of the education event module and presentation system.

FIG. 7 is an example of a session summary screen display of the education event module and presentation system.

FIG. 8 is an example of a session map screen display of the education event module and presentation system.

FIG. 9 is an example of a knowledge capsule screen display of the education event module and presentation system.

FIG. 10 is an example of a submit takeaways and concerns screen display of the education event module and presentation system.

FIG. 11 is an example of an add URL links to lesson screen display of the education event module and presentation system.

FIG. 12 is an example of a search learning desktop screen display of the education event module and presentation system.

FIG. 13 is an example of a search results screen display of the education event module and presentation system.

FIG. 14 illustrates a process for designing and using a content capsule.

### DETAILED DESCRIPTION OF CERTAIN EMBODIMENTS

The following detailed description of certain embodiments presents various descriptions of specific embodiments of the present invention. However, the present invention can be embodied in a multitude of different ways as defined and covered by the claims. In this description, reference is made to the drawings wherein like parts are designated with like numerals throughout.

Technical Terms

The following provides a number of useful possible definitions of terms used in describing certain embodiments of the disclosed invention. In general, a broad definition of a term is desired when alternative meanings exist.

A network may refer to a network or combination of networks spanning any geographical area, such as a local area network, wide area network, regional network, national network, and/or global network. The Internet is an example of a current global computer network. Those terms may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communications service (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), or frequency division multiple access (FDMA), among others.

A website may refer to one or more interrelated web page files and other files and programs on one or more web servers. The files and programs are accessible over a computer network, such as the Internet, by sending a request using a protocol, for example hypertext transfer protocol (HTTP), specifying a uniform resource locator (URL) that identifies the location or generation of one of said web page files, wherein the files and programs are owned, managed or authorized by a single business entity. Such files and programs can include, for example, hypertext markup language (HTML) files, common gateway interface (CGI) files, and Java applications. The web page files preferably include a home page file that corresponds to a home page of the website. The home page can serve as a gateway or access point to the remaining files and programs contained within the website. In one embodiment, all of the files and programs are located under, and accessible within, the same network domain as the home page file. Alternatively, the files and programs can be located and accessible through several different network domains.

A web page or electronic page may comprise that which is presented by a standard web browser in response to an HTTP request specifying the URL by which the web page file is identified. A web page can include, for example, text, images, sound, video, and animation.

The Standard Generalized Markup Language (SGML) is an international standard for describing the structure and content of machine-readable information. SGML “documents” usually consist of text, graphics, and hypertext links. SGML identifies and names the parts of the information so that these parts can be managed and manipulated to create a variety of products as diverse as typesetting, indexing, CD-ROM distribution, serving as hypertext over the Web, and translation into foreign languages. The Extensible Markup Language (XML) is a derivative dialect of SGML designed for use on the World Wide Web and in Intranets. XML is essentially a stripped-down version of SGML. Thus, a valid XML document is generally also a valid SGML document. XML is therefore useful for implementing the most commonly used SGML features. Information on the specifications for SGML and XML can be found on the Internet at http://www.w3.org.

A computer or computing device may be any processor controlled device that may permit access to the Internet, including terminal devices, such as personal computers, workstations, servers, clients, mini-computers, main-frame computers, laptop computers, a network of individual computers, mobile computers, palm-top computers, hand-held computers, set top boxes for a television, other types of web-enabled televisions, interactive kiosks, personal digital assistants, interactive or web-enabled wireless communications devices, mobile web browsers, pagers, cellular phones, or a combination thereof. The computers may further include one or more input devices such as a keyboard, mouse, touch-pad, joystick, pen-input-pad, or other input device. The computers may also include an output device, such as a visual display and an audio output. One or more of these computing devices may form a computing environment.

These computers may be uni-processor or multi-processor machines. Additionally, these computers may include an addressable storage medium or computer accessible medium, such as random access memory (RAM), an electronically erasable programmable read-only memory (EEPROM), programmable read-only memory (PROM), erasable programmable read-only memory (EPROM), hard disks, floppy disks, laser disk players, digital video devices, compact disks, video tapes, audio tapes, magnetic recording tracks, electronic networks, and other techniques to transmit or store electronic content such as, by way of example, programs and data. In one embodiment, the computers are equipped with a network communication device such as a network interface card, a modem, or other network connection device suitable for connecting to the communication network. Furthermore, the computers execute an appropriate operating system such as Linux, Unix, any of the versions of Microsoft Windows, Apple MacOS, IBM OS/2 or other operating system. The appropriate operating system may include a communications protocol implementation that handles all incoming and outgoing message traffic passed over the Internet. In other embodiments, while the operating system may differ depending on the type of computer, the operating system provides the appropriate communications protocols to establish communication links with a network such as the Internet.

The computers may contain program logic, or other substrate configuration representing data and instructions, which cause the computer to operate in a specific and predefined manner, as described herein. In one embodiment, the program logic may be implemented as one or more object frameworks or modules. These modules may be configured to reside on the addressable storage medium and configured to execute on one or more processors. The modules include, but are not limited to, software or hardware components that perform certain tasks. Thus, a module may include, by way of example, components, such as, software components, object-oriented software components, class components and task components, processes, functions, attributes, procedures, subroutines, segments of program code, drivers, firmware, microcode, circuitry, data, databases, data structures, tables, arrays, and variables.

The various components of the system may communicate with each other and other components comprising the respective computers through mechanisms such as, by way of example, interprocess communication, remote procedure call, distributed object interfaces, and other various program interfaces. Furthermore, the functionality provided for in the components, modules, and databases may be combined into fewer components, modules, or databases or further separated into additional components, modules, or databases. Additionally, the components, modules, and databases may be implemented to execute on one or more computers. In another embodiment, some of the components, modules, and databases may be implemented to execute on one or more computer external to the website. In this instance, the website includes program logic, which enables the website to communicate with the externally implemented components, modules, and databases to perform the functions as disclosed herein.

### DESCRIPTION OF THE FIGURES

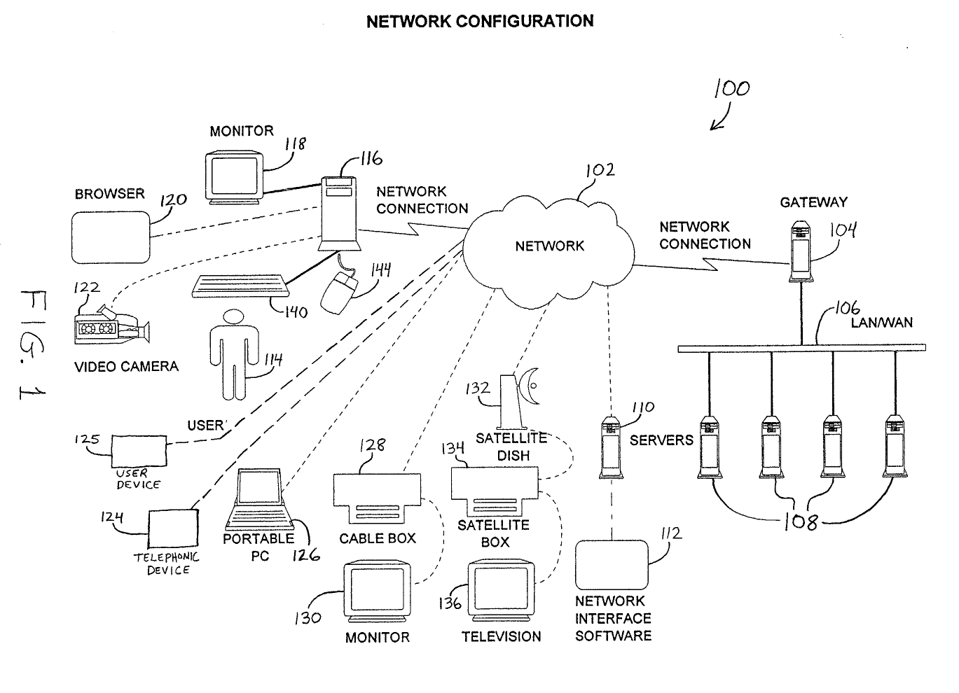

FIG. 1 is a diagram of one example of a network 100 configuration in which an education event module and presentation system may operate. However, various other types of electronic devices communicating in a networked environment may also be used. In this example, a user 114 communicates with a computing environment, which may include multiple server computers 108 or a single server computer 110, which may execute network interface software 112, in a client/server relationship on a network transmission medium 102 (referred to as “network” herein). The user 114 may include a plurality of types of users, for example an end user, an author, an administrator, or other users that may be accessing the computing environment for a variety of reasons. In a typical client/server environment, each of the server computers 108, 110 may include a server program that communicates with a user device 116, which may be a personal computer (PC), a hand-held electronic device (such as a PDA), a mobile or cellular wireless phone, a laptop computer, a TV set, or any number of other electronic devices.

The server computers 108, 110, and the user device 116 may each have any conventional general purpose single- or multi-chip microprocessor, for example a Pentium processor, a Pentium Pro processor, a MIPS processor, a Power PC processor, an ALPHA processor, or other general purpose processors. In addition, the microprocessor may be any conventional special purpose microprocessor such as a digital signal processor or a graphics processor. Additionally, the server computers 108, 110 and the user device 116 may be desktop, server, portable, hand-held, set-top, or other desired type of computing device. Furthermore, the server computers 108, 110 and the user device 116 each may be used in connection with various operating systems, including, for example, UNIX, LINUX, Disk Operating System (DOS), VxWorks, PalmOS, OS/2, Mac OS, a version of Microsoft Windows, or other operating system.

The server computers 108, 110 and the user device 116 may each include a network terminal equipped with a visual display 118, for example a computer monitor, a keyboard 140 and pointing device 144. In one embodiment of the network configuration 100, the user device 116 includes a network browser 120 used to access the server computers 108, 110. The network browser 120 may be, for example, Microsoft Internet Explorer or Netscape Navigator. The user 114 at the user device 116 may utilize the browser 120 to remotely access the server program using the keyboard 140, the pointing device 144, and/or the visual display 118. Although FIG. 1 shows only one user device 116, the network configuration 100 may include any number and type of user devices. In another embodiment, an analog or digital video camera 122, still picture camera, or other device for capturing, recording or saving moving or still images may be connected to the user device 116.

The network 102 may be any type of electronic transmission medium, for example, including but not limited to the following networks: a virtual private network, a public Internet, a private Internet, a secure Internet, a private network, a public network, a value-added network, an intranet, an extranet, or a wireless gateway. In addition, the connectivity to the network 102 may be, for example, via a modem, Ethernet (IEEE 802.3), Token Ring (IEEE 802.5), Fiber Distributed Datalink Interface (FDDI), Asynchronous Transfer Mode (ATM), Wireless Application Protocol (WAP), or other form of network connectivity. The user device 116 may connect to the network 102 by use of a modem or by use of a network interface card that resides in the user device 116. The server computers 108 may be connected via a local area network or wide area network 106 to a network gateway 104, which provides access to the local area network or wide area network 106 via a high-speed, dedicated data circuit.

As would be understood by one skilled in the technology, devices other than the hardware configurations described above may be used to communicate with the server computers 108, 110. If the server computers 108, 110 are equipped with voice recognition or Dual Tone Multi-Frequency (DTMF) hardware, the user 114 may communicate with the server computers by use of a telephonic device 124. The telephonic device 124 may optionally be equipped with a display screen and a browser 120. Other examples of connection devices for communicating with the server computers 108, 110 include a portable personal computer (PC) or a personal digital assistant (PDA) device 126 with a modem or wireless connection interface, a cable interface device 128 connected to a visual display 130, or a satellite dish 132 connected to a satellite receiver 134 and a television 136. Still other methods of allowing communication between the user 114 and the server computers 108, 110 are additionally within the scope of the invention and are shown in FIG. 1 as a generic user device 125. The generic user device 125 may be any of the computing or communication devices listed above, or any other device enabling a user to communicate with another device over a network.

Additionally, the server computers 108, 110 and the user device 116 may be located in different rooms, buildings or complexes. Moreover, the server computers 108, 110 and the user device 116 could be located in different geographical locations, for example in different cities, states or countries. This geographic flexibility which networked communications allows is within the scope of the invention.

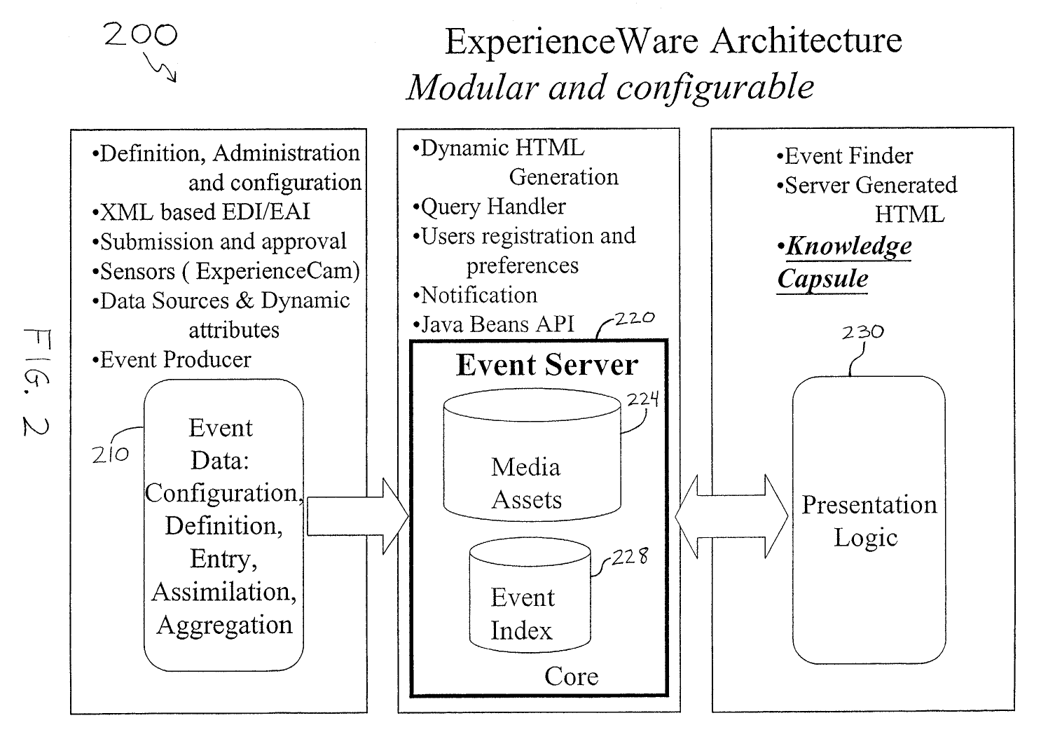

FIG. 2 is a diagram of an architecture of an event data module 200 in accordance with one embodiment of an education event module and presentation system. The event data module 200 is herein referred to as an ExperienceWare module 200 as labeled in FIG. 2. The embodiment shown in FIG. 2 includes an event data module 210, an event server module 220, and a presentation logic module 230. Additional embodiments of the education event module and presentation system may include more modules or fewer modules, and such additional embodiments are also within the scope of the present invention. The event data module 210 performs various operations and may include various submodules, for example definition, administration and configuration, XML-based electronic data interchange (EDI) or enterprise application integration (EAI), submission and approval, sensors, data sources and dynamic attributes, or an event producer. The event data module 210 performs configuration, definition, entry, assimilation, and/or aggregation operations. The event data module 210 may include more modules or fewer operations or submodules, and such additional embodiments are also within the scope of the present invention.

The ExperienceWare module 200 further includes the event server module 220, which is in data communication with the event data module 210. The event server module 220 of this embodiment includes media assets 224 and an event index 228. The event server module 220 may perform various operations and may include various submodules, for example dynamic hypertext markup language (HTML) generation, a query handler, user registration and preferences, notification, and a Java Beans application program interface (API). The event server module 220 may include more modules or fewer operations or submodules, and such additional embodiments are also within the scope of the present invention.

The ExperienceWare module 200 further includes the presentation logic module 230, which may perform various operations and may include various submodules, for example an event finder, a server-generated HTML submodule, and a knowledge capsule. The knowledge capsule is described in further detail below in relation to the knowledge capsule screen display of FIG. 9. The presentation logic module 230 may include more modules or fewer operations or submodules, and such additional embodiments are also within the scope of the present invention.

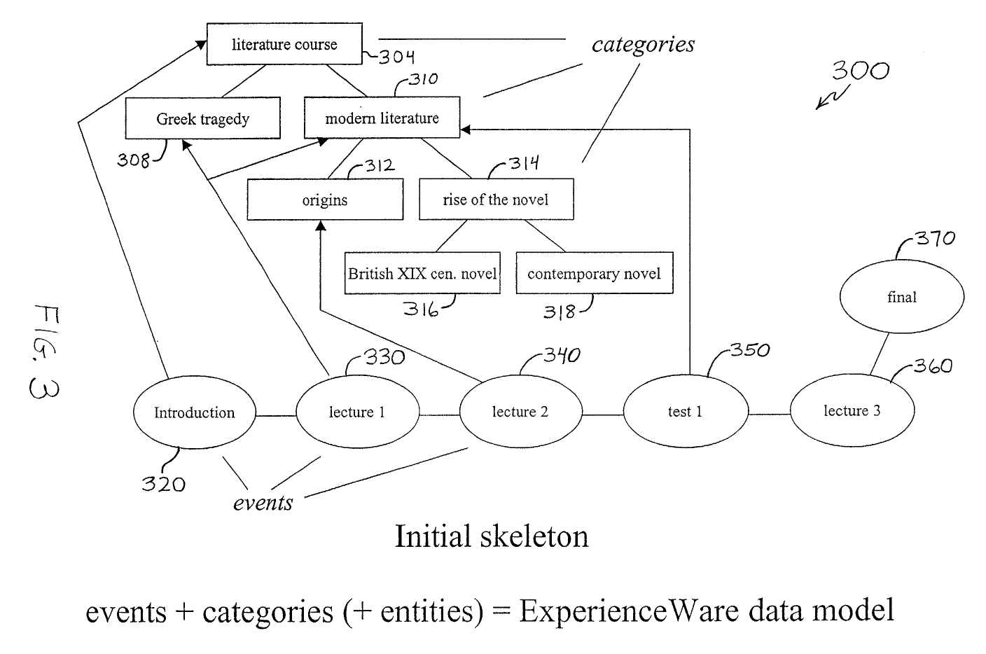

FIG. 3 is a block diagram of an initial skeleton of a course data model 300 according to one embodiment of the ExperienceWare module shown in FIG. 2. FIGS. 3, 4, and 5 show a sequence of data model creation, followed by knowledge capsule (also referred to as an event envelope) creation for the learning desktop. The course data model in this embodiment is stored in the event index 228 on the event server 220. The event server 220 may be accessed over the computer network 102, for example the Internet, by the user device 116, also referred to as a client computing device, executing the browser 120.

The initial skeleton of the course data model 300 shown in FIG. 3 illustrates one example of course categories, events and entities as initially planned and designated by the course instructor, teacher, professor or other course educator. In one embodiment, an event submission tool, which may be a software tool or module, is used to populate the course database with course categories, events and entities. As shown by the example of FIG. 3, the course data model may include a category tree structure associated with the course subject matter. In this example, a literature course 304 is decomposed into a Greek tragedy 308 category and a modem literature 310 category. The modem literature 310 category is further decomposed into other categories 312, 314, 316, 318 as shown in FIG. 3. In this embodiment, the course instructor adds one or more events to the course, for example an Introduction event 320, a lecture 1 event 330, a lecture 2 event 340, a test 1 event 350, a lecture 3 event 360, or a final exam event 370. Events may have associated stored entity descriptions. In the education embodiment shown in FIG. 3, the entities are instructor and students. Each entity may have various profile data elements associated with it, for example a name element, an email address element, or other profile data elements. As shown in FIG. 3, the events are temporally ordered from start (left side of FIG. 3, item 320) to finish (right side of FIG. 3, item 370).

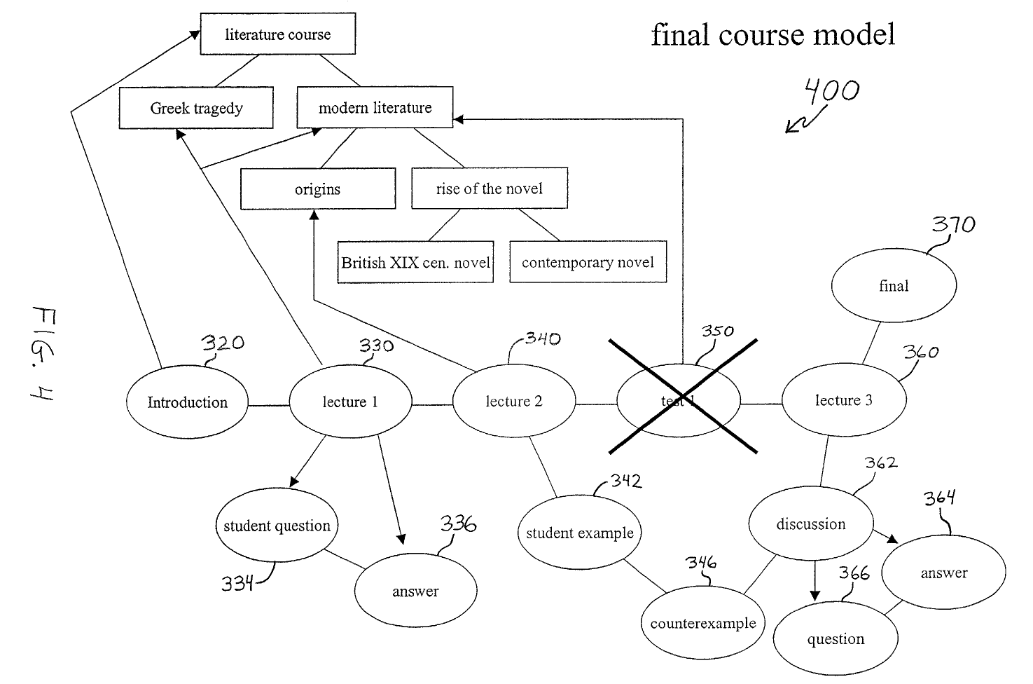

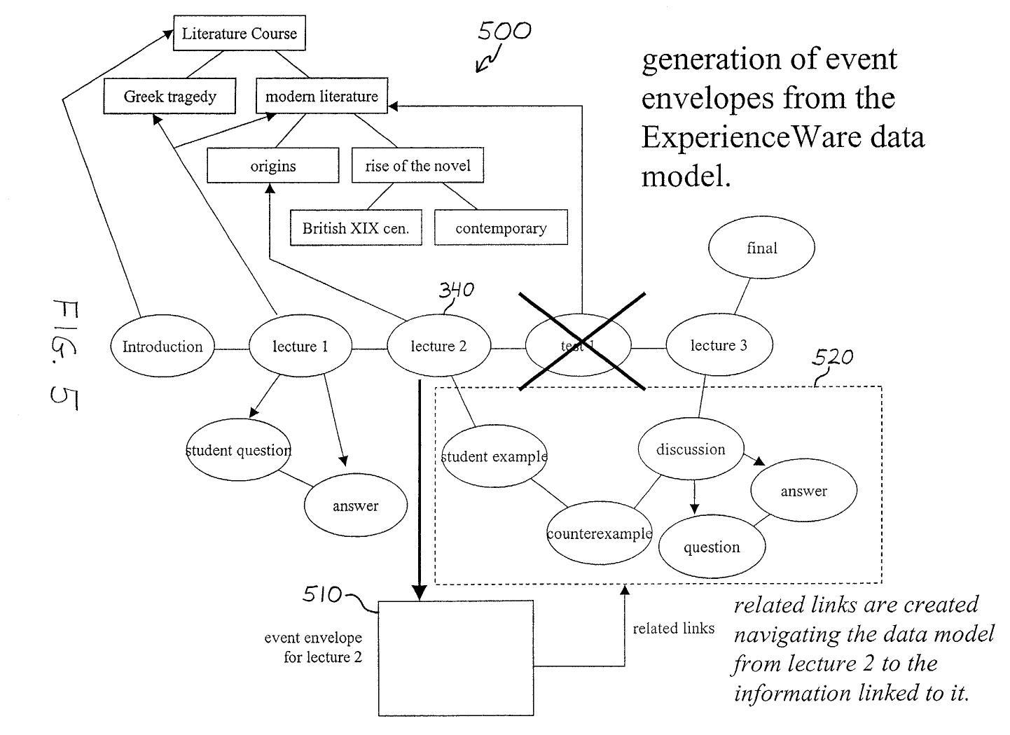

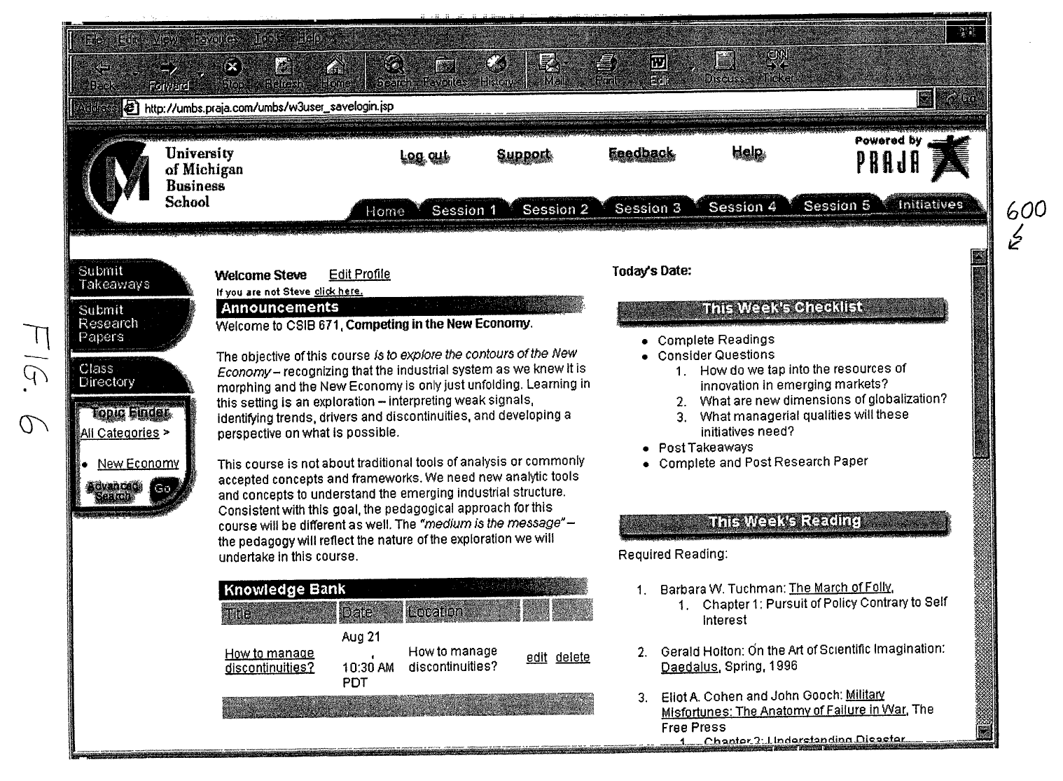

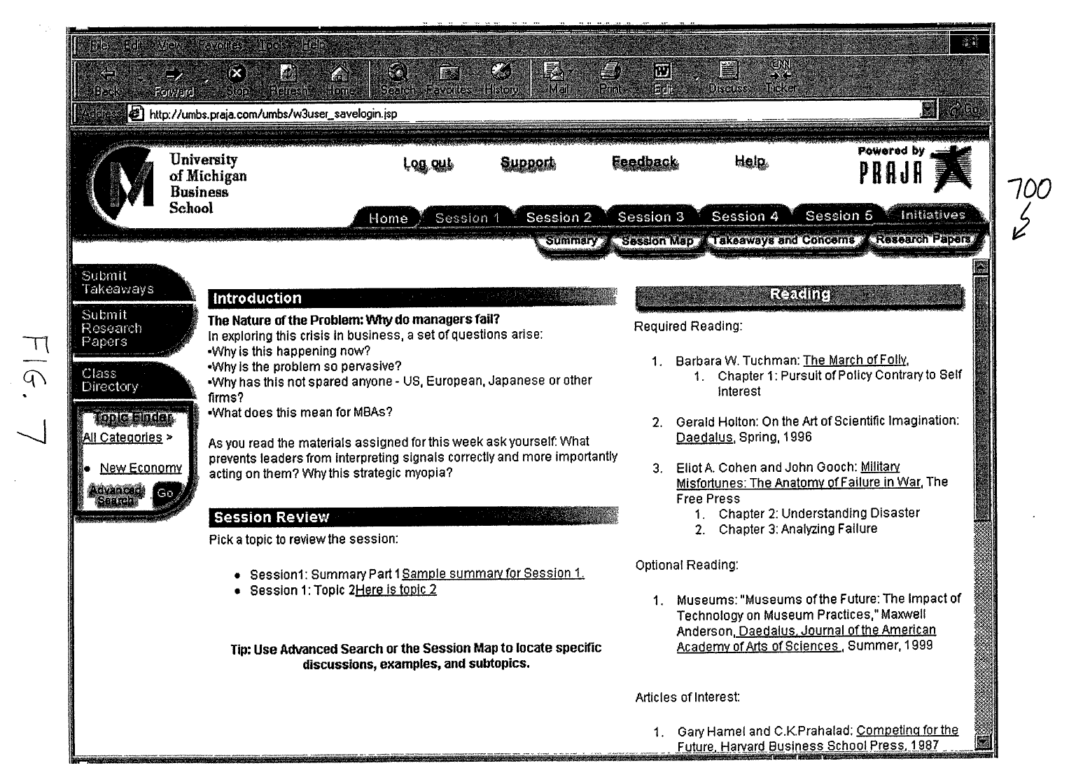

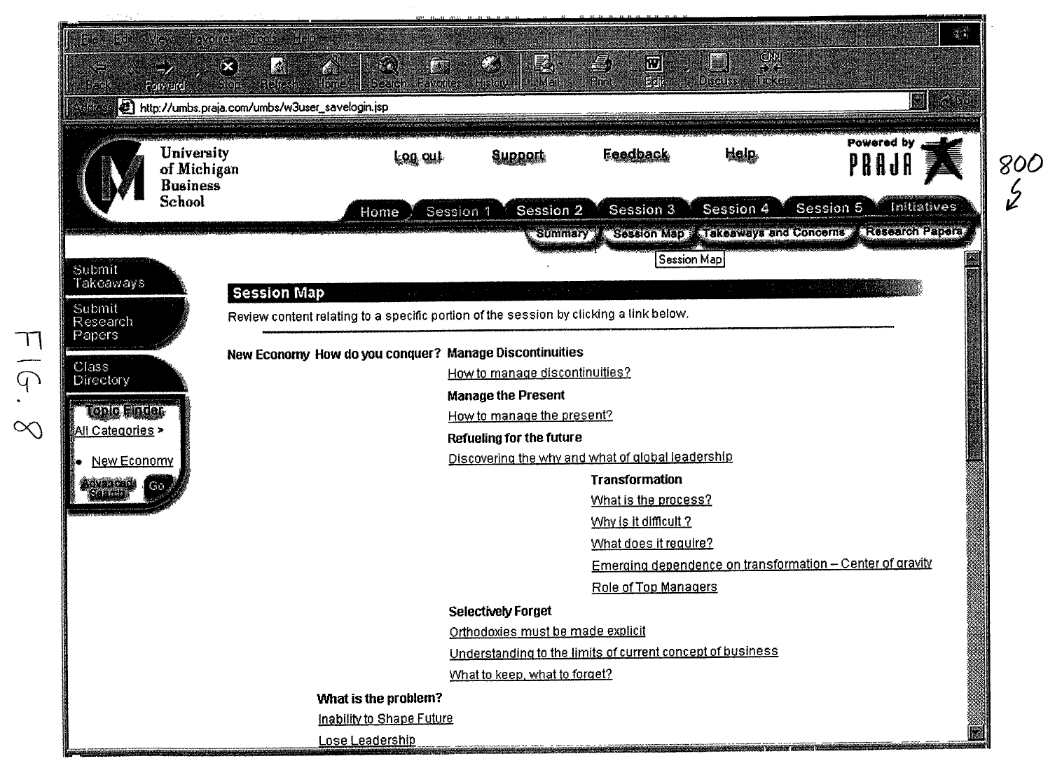

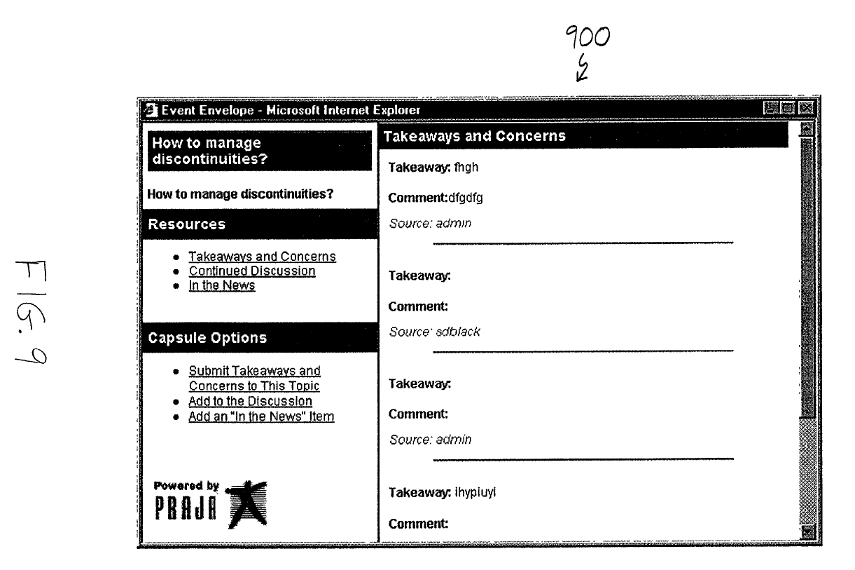

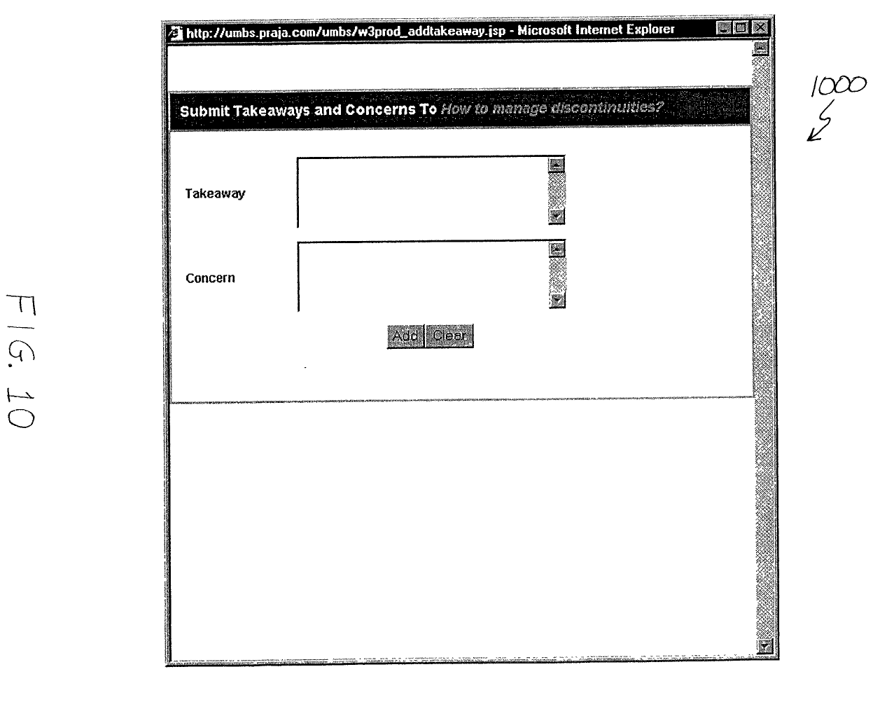

FIG. 4 is a block diagram of a final course data model 400 according to one embodiment of the ExperienceWare module 200 shown in FIG. 2. The final course data model 400 in this embodiment results from the iterative and collaborative manipulation of the course database by the course entities (instructor and one or more students). The final course data model 400 may be saved and can be reused by later course participants. In designating the final course data model 400, in one embodiment the categories are not changed from the initial skeleton of the course data model 300, but events may be added, modified or removed. The student may suggest changes, for example, via a takeaway/concern, which will be described in further detail below in relation to FIG. 10. In this embodiment, the course instructor approves the event changes before the changes are incorporated in the final course data model 400. An event can be associated with multiple sub-events, which may themselves be temporally related. For example, in the example of FIG. 4, the lecture 1 event 330 has been assigned a student question sub-event 334, and an answer sub-event 336 provided by the instructor. Additionally, the test 1 event 350 has been removed from the final course model 400. Further, a student example sub-event 342, a counterexample sub-event 346, a discussion sub-event 362, an answer sub-event 364, and a question sub-event 366 have been added to the lecture 2 event 340 and lecture 3 event 360 as shown in the example of the final course model 400 in FIG. 4.

FIG. 5 is a block diagram illustrating a generation of event envelopes 500 according to one embodiment of the ExperienceWare module 200 shown in FIG. 2. The example of FIG. 5 illustrates the presentation of the course database to a user 116, which may be a course student, with an event envelope 510. In one embodiment, web pages are dynamically generated, for example, using HTML code. The web page may be emailed from one student to another. As shown below in the screen displays of FIGS. 6-13, hot links may be embedded in a session map to automatically launch an event envelope 510. The contents of the sample event envelope in FIG. 5 are represented by a dashed box 520. In this example, the sub-events of the lecture 2 event 340 have been navigated to and incorporated into the event envelope 510. A link in the dynamically created web page of the event envelope may be to an event, an entity, or in certain embodiments to a data source external to the data model, for example located on other servers or computers on the Internet. In one embodiment, the system may be configured to provide static or dynamic links upon creation of an event envelope 510. Thus, if static envelopes are defined, later changes made in the database at the event server will not be incorporated into the view provided by the event envelope 510, which may be desired in certain situations. In another embodiment, the view is not personalized, for example, if one student creates an event envelope 510, a substantially similar web page is displayed to another student after receipt via email. Still further embodiments may change the view according to a user profile.

FIG. 6 is an example of a learning desktop screen display 600 of the education event module and presentation system. FIG. 6 shows, by way of example only, one of many possible screen displays that may be employed by the system and method of the present invention. Therefore, the scope of the present invention is not limited to the screen display shown in FIG. 6, but instead embraces the many possible such screen displays, as well as numerous other ways of presenting information to a user. In one embodiment, the learning desktop is a gateway, i.e. a starting point, for students taking a course utilizing the education event module and presentation system. The learning desktop screen display 600 includes a dynamic interactive learning environment that facilitates dialogue and collaboration between students and the instructor via, for example, multiple access and contact points. Collaboration and dialogue is maintained via the real-time interactive community features of the learning desktop.

The learning desktop additionally includes the knowledge capsule mentioned above in relation to FIG. 2, which is described in further detail below in relation to FIG. 9. One embodiment of the knowledge capsule provides a one-stop destination for course concept media, for example real-time discussions and chat, hot links to related topics, gateways to submit course requirements or assignments such as papers, or the ability to archive and store each capsule in a personal knowledge bank. Students are able to annotate in real time each capsule by adding related links and discussion threads, creating a dynamic learning repository of collective insight and experience that can be distributed among students, for example, via email. The knowledge capsule may additionally provide single click access to previous sessions, which may include archived, indexed video embedded in the capsule, for example via Praja's QuickView tool. Students may additionally review previous sessions with related links and can search archived video for specific references or comments. In one embodiment, the elements of the learning desktop are dynamically rendered based on time, since content may change periodically. Additionally, a topic finder may be provided to allow students to quickly drill down to a learning event, which may be categorized by content.

FIG. 7 is an example of a session summary screen display 700 of the education event module and presentation system. FIG. 7 shows, by way of example only, one of many possible screen displays that may be employed by the system and method of the present invention. Therefore, the scope of the present invention is not limited to the screen display shown in FIG. 7, but instead embraces the many possible such screen displays, as well as the numerous other ways of presenting information to a user. In one embodiment, the session summary screen display 700 is displayed by selecting the Session 1 tab in the learning desktop screen display 600 (see FIG. 6). The session summary screen display 700 example includes a horizontal navigation bar near the top of the display that is divided into tabs that correlate to each session to be taken by students in the course, here sessions 1-5. Also included is a vertical navigation bar near the left side of the display having selection tabs enabling students to: 1) submit comments or takeaways for each class; 2) submit a research paper; 3) identify other students in the course and locate information about them, for example email addresses; or 4) search the website using standard world wide web search criteria.

The session summary screen display 700 may additionally include a horizontal navigation bar providing more explicit information to the student regarding the session. In addition, dynamically rendered content may be included that is managed by the platform. Additionally, a session review feature may be included. The session review is a specialized knowledge capsule where learning summaries are published for the session, for example by Praja's QuickView product. The session review knowledge capsule contains archived video of the session so that students can review specific parts of the previous sessions when requested by the student.

FIG. 8 is an example of a session map screen display 800 of the education event module and presentation system. FIG. 8 shows, by way of example only, one of many possible screen displays that may be employed by the system and method of the present invention. Therefore, the scope of the present invention is not limited to the screen display shown in FIG. 8, but instead embraces the many possible such screen displays, as well as the numerous other ways of presenting information to a user. The session map screen display 800 example of FIG. 8 provides a graphical rendition of the course structure for the selected session, allowing students to jump to any point in the particular session. For example, the underlined text in the screen display of FIG. 8 represent hot links that launch a knowledge capsule that can be stored in the student's personal knowledge bank.

FIG. 9 is an example of a knowledge capsule screen display 900 of the education event module and presentation system. FIG. 9 shows, by way of example only, one of many possible screen displays that may be employed by the system and method of the present invention. Therefore, the scope of the present invention is not limited to the screen display shown in FIG. 9, but instead embraces the many possible such screen displays, as well as the numerous other ways of presenting information to a user. In one embodiment, one element of the learning desktop is the knowledge capsule, which is a one-stop destination of information about course or session concepts. Each concept has a knowledge capsule containing related information about the concept, for example resources, topical information, discussion, or other related course information. The knowledge capsule performs that collaborative operations of the learning desktop, allowing students to share, append and archive the knowledge capsule.

The knowledge capsule screen display 900 example of FIG. 9 additionally provides a one-stop destination for course concept media, encompassing real-time discussion and chat, hot links to related topics, gateways to submit course requirements such as papers, or the ability to archive and store each capsule in a personal knowledge bank. Concepts, sessions and course participants have a corresponding knowledge capsule. Elements of the course are dynamically rendered in a collaborative format. Additionally, students may annotate in real time each knowledge capsule, for example by adding related links and discussion threads, thus creating a dynamic learning repository of collective insight and experience that can be distributed among students, for example, via email.

The knowledge capsule screen display 900 example of FIG. 9 additionally provides a single click access to one or more previous sessions. Archived, indexed video may be embedded in the knowledge capsule, for example via the QuickView tool. Thus, students may review previous sessions with related links and may search archived video for specific references or comments. Knowledge capsules may be distributed to other students, for example, via email or other electronic communication. Students may additionally receive notification of changes to knowledge capsules. The knowledge capsule archives may be archived in a student's personal knowledge bank. Additionally, the knowledge capsule has collaborative features, for example capturing students' implicit knowledge in the capsule and distributing it to other students so they may benefit from group knowledge and expertise.

FIG. 10 is an example of a submit takeaways and concerns screen display 1000 of the education event module and presentation system. FIG. 10 shows, by way of example only, one of many possible screen displays that may be employed by the system and method of the present invention. Therefore, the scope of the present invention is not limited to the screen display shown in FIG. 10, but instead embraces the many possible such screen displays, as well as the numerous other ways of presenting information to a user. The submit takeaways and concerns screen display 1000 example shown in FIG. 10 may be reached by selecting an appropriate link in the resources section of the knowledge capsule. Students may submit a takeaway and concern for each session, either optionally or as part of the course requirements.

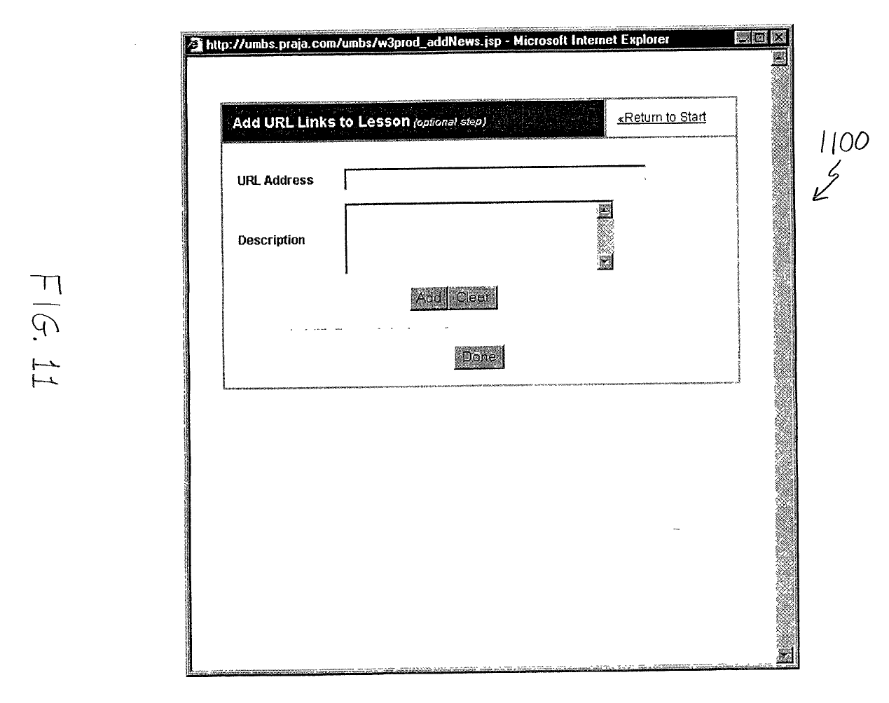

FIG. 11 is an example of an add URL links to lesson screen display 1100 of the education event module and presentation system. FIG. 11 shows, by way of example only, one of many possible screen displays that may be employed by the system and method of the present invention. Therefore, the scope of the present invention is not limited to the screen display shown in FIG. 11, but instead embraces the many possible such screen displays, as well as the numerous other ways of presenting information to a user. The add URL links to lesson screen display 1100 may be reached by selecting an appropriate link in the resources section of the knowledge capsule. Students may submit links to relevant data for each session of a course.

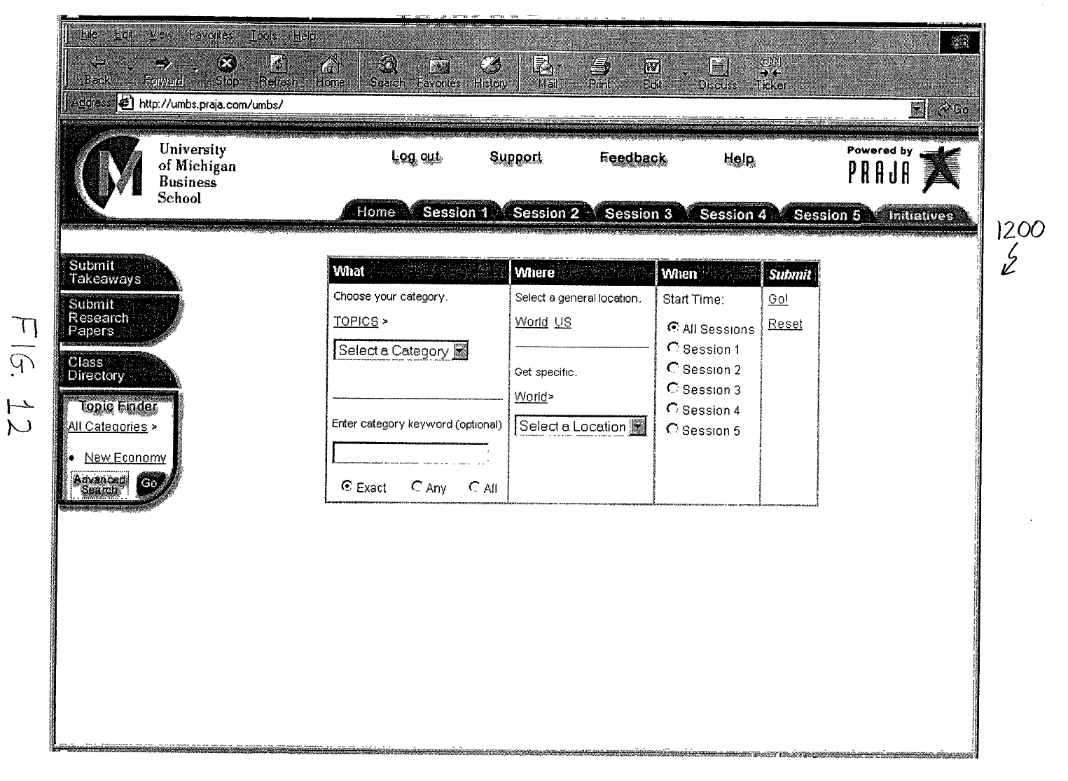

FIG. 12 is an example of a search learning desktop screen display 1200 of the education event module and presentation system. FIG. 12 shows, by way of example only, one of many possible screen displays that may be employed by the system and method of the present invention. Therefore, the scope of the present invention is not limited to the screen display shown in FIG. 12, but instead embraces the many possible such screen displays, as well as the numerous other ways of presenting information to a user. The search learning desktop screen display 1200 example as shown in FIG. 12 illustrates the time, space and location search capability of the learning desktop. The search is multi-dimensional and retrieves information across all media. The student is not restricted to looking only for information that is text based, but may search concepts, video assets, course participants, course content topics, and other media resources.

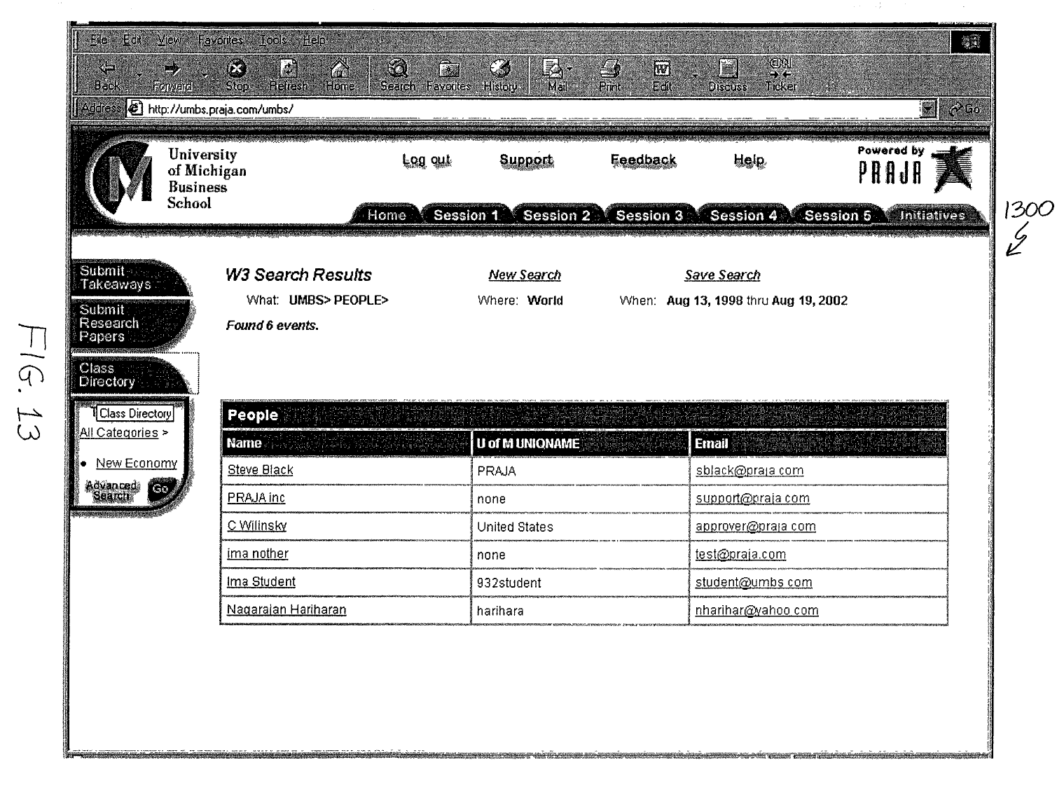

FIG. 13 is an example of a search results screen display 1300 of the education event module and presentation system. FIG. 13 shows, by way of example only, one of many possible screen displays that may be employed by the system and method of the present invention. Therefore, the scope of the present invention is not limited to the screen display shown in FIG. 13, but instead embraces the many possible such screen displays, as well as the numerous other ways of presenting information to a user. The search results screen display 1300 illustrates one example of the collaborative aspects of the learning desktop of the present invention. The multi-dimensional search can retrieve information about course participants, for example, which is rendered in the knowledge capsule. The knowledge capsule may contain student information, for example, contact details or other student information, enabling fellow students to maintain a directory of class participants that may be accessed when requested.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes that come within the meaning and range of equivalency of the claims are to be embraced within their scope.

What is claimed is:

1. A method of modeling an educational course, the method comprising:
defining a category tree having a plurality of category nodes, wherein a plurality of the category nodes are representative of aspects of a course;
associating at least one event with one of the nodes, wherein the event has an event description; and
transmitting an electronic document from an educational server to a student, wherein the electronic document includes a hyperlink to the event.

2. A system for modeling an educational course, the system comprising:
an event data module adapted to provide input mechanisms for entering course event data, wherein the input mechanisms comprise the configuration, definition, entry, assimilation and aggregation of course event data;
an educational server adapted to process and store media assets and event index data for course events; and
a presentation logic module adapted to transmit an electronic document from an educational server to a student, wherein the electronic document includes a hyperlink to the event.
